(19) United States
(12) Patent Application Publication
(10) Pub. No.: US 2026/0170379 A1
(43) Pub. Date: Jun. 18, 2026

(54) CIRCUIT-DEFINED QUBIT STATE MEASUREMENT

(71) Applicant: Dell Products L.P., Round Rock, TX (US)

(72) Inventors: Brendan Burns Healy, Haddonfield, NJ (US); Rômulo Teixeira de Abreu Pinho, Niterói (BR)

(21) Appl. No.: 18/978,291

(22) Filed: Dec. 12, 2024

(51) Int. Cl. G06N 10/40; G06N 10/60

(52) U.S. Cl. CPC G06N 10/40; G06N 10/60

(57) ABSTRACT

Re-creating quantum circuits using auxiliary or spare qubits to improve performance of a quantum computing system is disclosed. In one example, separable qubits are replicated to auxiliary qubits and the quantum circuit is recreated to include the auxiliary qubits. Executing the quantum circuit allows additional information regarding at least qubits of interest to be acquired by measuring the auxiliary qubits along a different axis than the original qubits. Because the original and auxiliary qubits have the same state due to the replication, measuring along a different access provides addition information. This improves the performance of the quantum computing system and may reduce the number of shots otherwise required.

### TECHNOLOGICAL FIELD OF THE DISCLOSURE

Embodiments disclosed herein generally relate to quantum computing systems, quantum circuits, and/or qubit state measurement. More particularly, at least some embodiments relate to systems, hardware, software, computer-readable media, and methods for measuring qubit states in quantum circuits using spare or auxiliary qubits.

### BACKGROUND

Quantum processing units (QPUs) are, simply stated, the engine or processor of a quantum computing system. While a bit is a basic unit of data or information in classic computing, a qubit is the equivalent unit in quantum computing. In contrast to conventional bits, a qubit is not limited to being 0 or 1. A qubit can exist in a superposition of both states simultaneously. In addition, qubits in a quantum computing system can be entangled, which essentially means that the state of one qubit may depend on the state of another qubit. This is one of the reasons that quantum computing systems are potentially more powerful than classical computing.

Quantum computing systems are typically associated with some number of qubits (e.g., n qubits). As a result, quantum computing systems with n qubits can represent information in a (superposition) space of size 2ⁿ. Due to the presence of noise in a quantum computing system, the number of shots required to extract the information stored in the 2ⁿ space via measurement operations is O(2ⁿ). This reflects a large performance penalty, which may impact the advantages afforded by quantum computing systems.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1A illustrates a geometric interpretation of a quantum system with one qubit forming a vectorial basis with two components (|0 [symbol] and |1 [symbol] );

FIG. 1B illustrates an evolution of a probability distribution as the number of shots performed in a quantum computing system increases;

FIG. 2 discloses aspects of a quantum computing system configured to execute quantum jobs;

FIG. 3 discloses aspects of a quantum circuit configured to be run or executed in a quantum computing system;

FIG. 4 discloses aspects of replicating an original qubit to an auxiliary or spare qubit of a quantum computing system;

FIG. 5 discloses aspects of measuring a qubit from the perspective of a Bloch sphere;

FIG. 6 discloses additional aspects of replicating an original qubit to an auxiliary qubit of a quantum computing system;

FIG. 7 discloses aspects of executing a quantum circuit in a quantum computing system; and

FIG. 8 discloses aspects of a computing device, system, or entity.

### DETAILED DESCRIPTION OF SOME EXAMPLE EMBODIMENTS

Embodiments disclosed herein generally relate to quantum computing systems and measuring qubit states. More particularly, at least some embodiments relate to systems, hardware, software, computer-readable media, and methods for measuring qubit states using spare or auxiliary qubits.

Example embodiments of the invention are discussed in the context of quantum computing systems. Examples of quantum computing systems may include, but are not limited to, real or physical quantum computing systems, emulated quantum computing systems, and the like. Embodiments of the invention relate more specifically to real quantum computing systems configured to execute quantum circuits or gate-based quantum computing.

Gate-based quantum computing is a generic form of quantum computation. Gate-based quantum computing systems execute quantum circuits, which are instances of quantum algorithms. The quantum circuit contains a set of instructions or operations (e.g., gates) that manipulate quantum states.

Quantum bits, or qubits, in a quantum circuit, form a vectorial basis with 2ⁿ components, where n is the number of qubits. Linear combinations of the components of the basis form the quantum states. A measurement is a projection of the final quantum state, at the end of the quantum algorithm, onto one component of the basis. Stated differently, the quantum state collapses onto one of the components. Following the rules of quantum physics, the collapse is probabilistic, and the probability of a state collapsing onto one of the components is equal to the square of the magnitude of the (complex) amplitude of the state along that component.

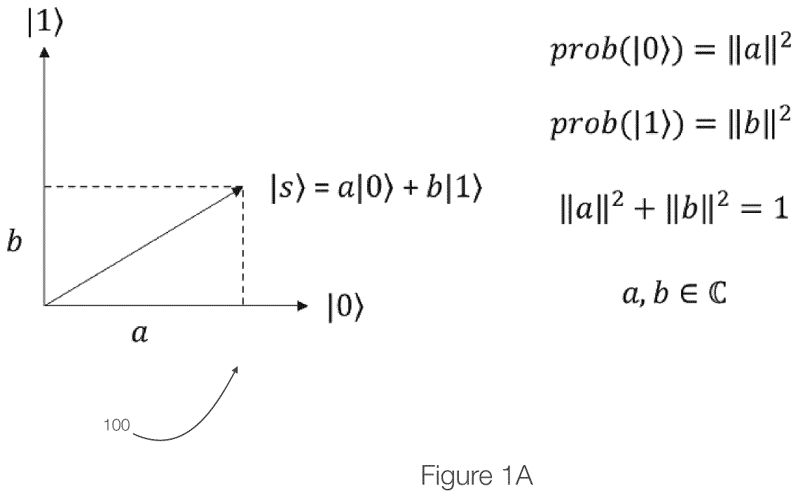

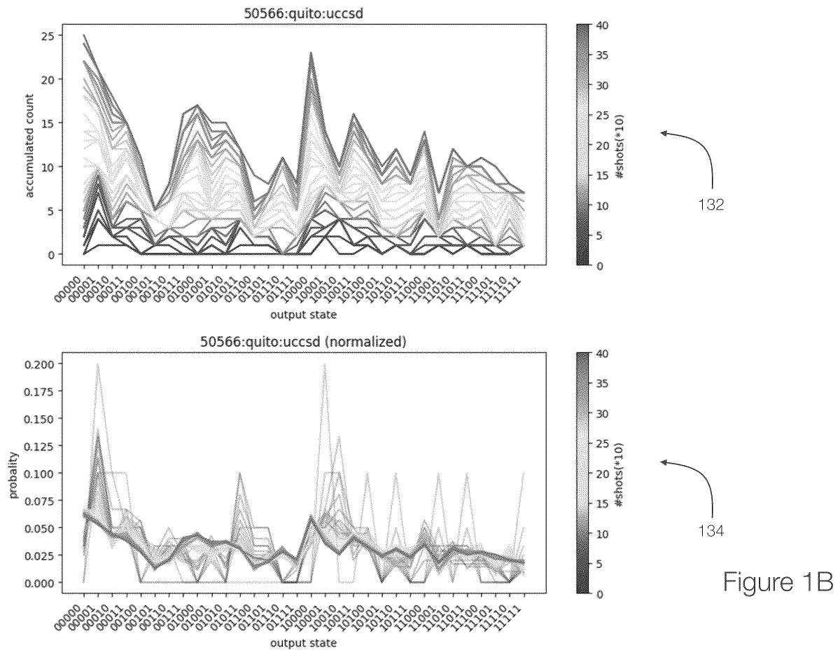

FIG. 1A illustrates a geometric interpretation of a quantum system with one qubit forming a vectorial basis with two components (|0 [symbol] and |1 [symbol] ). In the geometric interpretation 100, the quantum state |s [symbol] is a linear combination (or superposition) between the components of the basis.

FIG. 1B illustrates an evolution of a probability distribution as the number of shots increases. In practice, and following the rules of quantum physics, the state vector |s [symbol] cannot be obtained directly. Due in part to the probabilistic nature of quantum circuits, multiple shots are performed. Each shot is an execution or run of the quantum circuit (or quantum algorithm). Each shot collapses onto one of the basis states via a measurement operation. After several shots, an estimate of the probability distribution that corresponds to the components of |s [symbol] can be determined up to some precision due to the stochastic nature of quantum computing.

This probability distribution evolves towards a stable configuration and the components of |s [symbol] can be derived from the stable configuration. The probability distribution of the output states is typically obtained by counting the number of times |s [symbol] collapses onto each component of the basis and then normalizing the counts to sum to 1.

FIG. 1B illustrates an example of an evolution of a probability distribution as the number of shots increases. In this example, 400 shots were performed and the quantum system included five qubits. Thus, the vectorial basis has 2⁵=32 components. The plot 132 illustrates an accumulated count of the number of times each basis component was measured at the output. The plot 134 illustrates normalized counts forming a probability distribution. The plot 134 illustrates that the probability distribution evolves to a stable configuration as more shots are executed.

As previously stated, noise can be a limiting factor in a quantum computing system. Noise can impact the probabilistic nature of quantum computations and augments the non-determinism of quantum circuit results. Further, executing multiple shots of a quantum circuit is costly and the right number of executions or shots needed to obtain or separate signal from noise is unknown in advance. Consequently, noisier systems often require more shots.

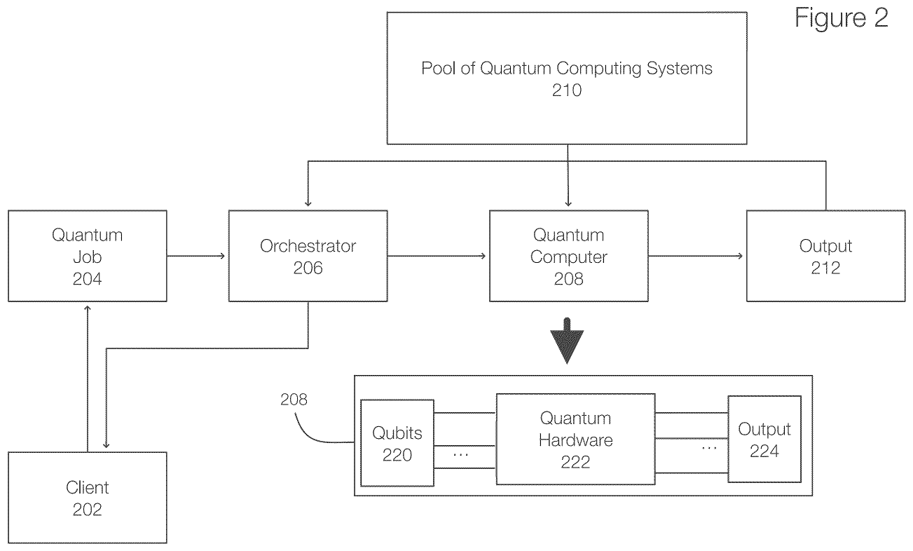

FIG. 2 discloses aspects of a quantum computing system configured to execute quantum jobs. FIG. 2 illustrates a client 202 that submits a quantum job 204 to an orchestrator 206. The orchestrator 206 may be implemented in classical computing systems and may be configured to manage the execution of quantum jobs received from clients. For example, in the context of orchestrating the execution of a quantum job, the orchestrator 206 may select a quantum computer 208 from a pool 210 of quantum computing systems (e.g., quantum computing systems available to the orchestrator 206).

The pool 210 may include real quantum computing systems, emulated quantum computing systems, hybrid quantum computing systems, and the like. The selection of the quantum computer 208 may be based on various factors such as, but not limited to, number of qubits, time constraints, accuracy requirements, characteristics of the quantum computers (e.g., noise characteristics), or the like or combinations thereof.

The orchestrator 206 may perform aspects of preparing the quantum job 204 for submission to the quantum computer 208. This may include formatting or converting the quantum job 204 to an appropriate format or form, mapping logical bits to qubits, or the like. The orchestrator 206 may perform circuit cutting, circuit knitting, transpilation parameter selection, circuit submission, job management, and the like.

The orchestrator 206 may also process the output 212 of the quantum computer 208 (e.g., collect shot measurements, normalize accumulated shot measurements). The final result may be provided back to the client 202. The orchestrator 206 may process the results to identify a final solution to the quantum job 204.

The quantum computer 208 typically includes n qubits 220 as input to quantum hardware 222. Performing a shot on the qubits 220, once initialized, in the quantum hardware 222 generates an output 224 (the output 212). Some quantum jobs may require k qubits (k<n). Embodiments of the invention use the unused qubits, referred to herein as spare or auxiliary qubits, to improve the performance of the quantum computer 208. As discussed in more detail below, some of the qubits in the original quantum circuit are replicated to the auxiliary qubits and rotated. This allows measurements to be performed along a different axis or perspective and allows more information to be acquired in each shot. This may advantageously reduce the number of shots that would otherwise be required to obtain the final state vector to any degree of precision.

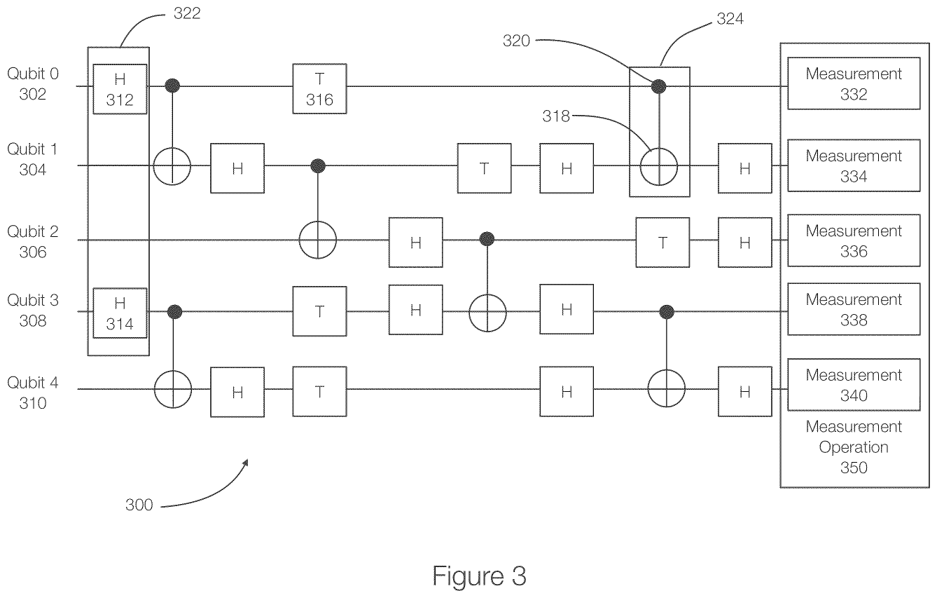

FIG. 3 discloses aspects of a quantum circuit configured to be run or executed in a quantum computing system. In this example, five qubits are illustrated: qubit 302, 304, 306, 308, and 310 (numbered from 0-4 or Q₀, Q₁, Q₂, Q₃, Q₄) in this example. FIG. 3 illustrates a time oriented view of circuit execution from left to right. After execution, each qubit is measured. Thus, the qubits 302, 304, 306, 308, and 310 are measured, respectively, at measurement 332, 334, 336, 338, and 340 (measurement operation 350). The measurement operation 350 effectively collapses the states onto a basis.

Each of the qubits 302, 304, 306, 308, and 310 may be subject to gates during circuit execution. In this example, a gate is an example of an operation that may be performed on a qubit. FIG. 2 illustrates, by way of example, a few possible gates. For example, a box with an H represents an Hadamard gate. A Hadamard gate is a single-qubit gate. A T gate (e.g., gate 316) is a gate configured to apply a phase shift to a qubit. A T gate is also a single qubit gate.

The gate 324 is an example of a 2 qubit gate and more specifically of a CNOT gate in this example. In the two qubit gate 324, a cross within a circle 318 represents a target qubit and the black dot 320 represents the control qubit. This gate 324 also represents an entanglement.

The quantum circuit 300 includes or is represented as having layers, an example of which is the layer 322. The quantum circuit 300 includes multiple layers and the layers are generally executed successively. In one example, a layer may include gates that can be applied at the same time because they act on different qubits. Thus, the gates 312 and 314 act on, respectively qubits 302 and 314. Thus, these gates 312 and 314 may be applied in parallel or in the same layer. The circuit 300 further illustrates, that operations or gates may be applied to each of the qubits in a time based or sequential manner.

During operation, shots of the quantum circuit 300 are executed and measurements 332, 334, 336, 338, and 340 are performed for each run or shot of the quantum circuit 300. As multiple shots are performed, the outputs are accumulated and may be normalized into a stable probability distribution.

As previously stated, the number of shots that need to be performed due in part to the presence of noise incurs a performance penalty. Embodiments of the invention relate, at least in part, to reducing the number of shots that need to be performed.

Embodiments of the invention allow the execution of the quantum circuit to be performed more quickly and efficiently using auxiliary qubits.

For example, a quantum circuit may require n qubits of a quantum computing system. If additional qubits are available, then a qubit qᵢ of a quantum circuit (or quantum algorithm) can be replicated onto a spare or auxiliary qubit qⱼ that is not used by the quantum circuit. More specifically, qᵢ_{ₐᵤₓ}=qⱼ and all operations involving qᵢ are replicated onto qᵢ_{ₐᵤₓ}. By doing this, information from the multiple sets {qᵢ, {qₖ|k≠i, k≠j}} and {qⱼ, {qₖ|k≠i, k≠j}} can be extracted from the output of each shot. Each of these sets have a size of 2ⁿ⁻¹. The number of sets can be increased when more spare qubits are used. Further, information for two sets can be extracted in a single shot of the quantum circuit. In general, for each spare or auxiliary qubit, the total number of shots can be reduced, by a factor of 2 in one example.

This illustrates that, depending on the operations (gates) present in a quantum circuit and on the amount of noise in the system, the resulting quantum state in the 2ⁿ space can be separated into the individual components (or the qubits) that form the composite state. These are referred to as separable states.

Embodiments of the invention include identifying when qubit replications are viable (i.e., separability conditions are satisfied) and include extracting multiple quantum states (or sets) from a single measurement. This improves the performance of quantum circuit executions. In one example, performance is improved by reducing the number of shots that would otherwise be required. Generally, extraction of more than one quantum state from the same set of qubits is possible when the states are separable.

Advantageously, embodiments of the invention also improve resource utilization by using auxiliary or otherwise unused qubits.

In one example, the orchestrator may re-create or reconfigure a quantum job (e.g., a quantum circuit) by replicating one or more of the qubits to auxiliary qubits. Replicating a qubit includes adding gates such that the auxiliary qubit is, in effect, a duplicate of the original qubit. Thus, a spare or auxiliary qubit (or set thereof) are transformed into a duplicate of an original qubit (or set thereof).

The duplicate qubits, in one example, are measured along a different axis. Thus, replication may include adding a gate that effectively rotates the qubit. Measuring the auxiliary qubits along a different axis provides additional information about the state of the qubit that cannot be obtained in a normal measurement. More specifically, the auxiliary qubit allows different measurements of essentially the same qubit to be obtained in a single shot. In one example, replication or duplication may include adding one or more gates in addition to replicating or duplicating the gates present on the qubit being replicated or duplicated.

In one example, a method includes two stages or steps: producing a replicated qubit state and measuring the qubit state along a different axis.

In one example, qubit replication is performed when the qubit being replicated (or duplicated) is only involved in 1 qubit gates or controlled 2 qubit gates as the control qubit. In one example, quantum circuits can be reduced to a basis set of gates that are all 1-qubit, or a controlled 2-qubit operation.

In one example, an original qubit (or set of original qubits) and an auxiliary qubit (or set of auxiliary qubits) are identified. All 1 qubit gates on the original qubit are duplicated to the auxiliary qubit. All 2 qubit gates using the original qubit as a control qubit are ignored. In addition, the replication is configured for the same layer (or immediately after) the original gate in the original quantum circuit or in a manner to insure that other intervening operations do not impact execution of the replicated qubit (e.g., causing the original and corresponding auxiliary qubit to be different or not in identical states).

If an original qubit is a target qubit, a layer may be added to the quantum circuit such that the auxiliary qubit can be kept in the same state as the original qubit. This layer may be executed on its own to maintain the appropriate states.

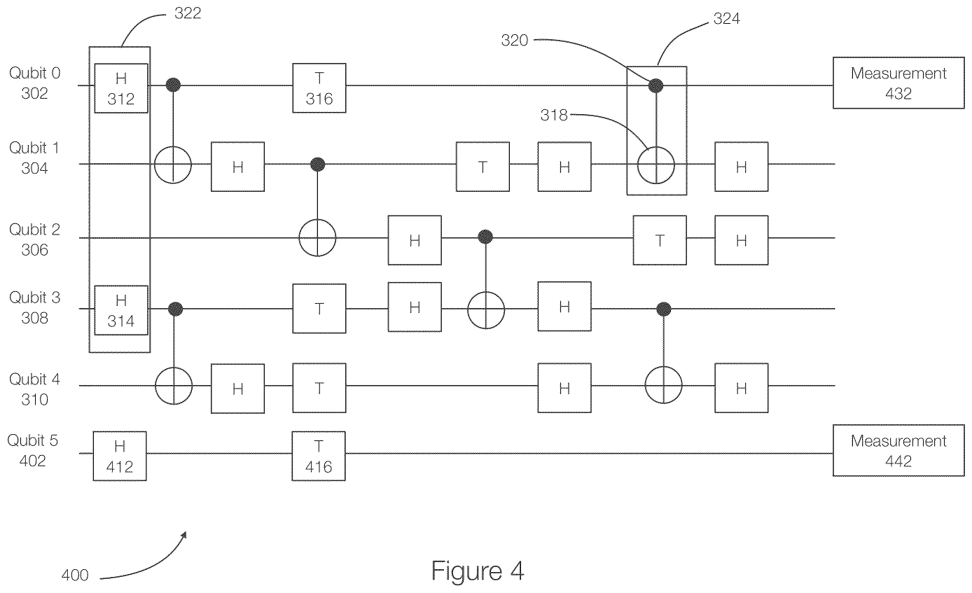

FIG. 4 discloses aspects of replicating a qubit. The quantum circuit 400 in FIG. 4 represents the quantum circuit 300, but with an auxiliary qubit 5 (qubit 402). The quantum circuit 400 is performed, in this example, on the same quantum computing system as the quantum circuit 300. During execution of the quantum circuit 300, some of the qubits were spare or auxiliary qubits. The quantum circuit 400 takes advantage of one of the auxiliary qubits by replicating the qubit 302 to one of the auxiliary qubits as the qubit 402.

During replication, which may be performed by the orchestrator, the gate 312 is replicated to the qubit 402 as the gate 412 and the gate 316 is replicated as the gate 416. The gate 324 is not replicated in this example at least because the qubit 302 is the control qubit and is ignored for replication purposes. In some example, the qubit selected for replication may be selected due to its importance or for other reasons.

During execution or during each shot, all 6 qubits (qubits 0-5 in this example) execute. Because the qubit 302 is replicated to the qubit 402, the qubit 402 and the qubit 302 have the same state during execution and when measured.

With the auxiliary qubit 402 in the same state as the original qubit 302, performing a measurement (e.g., measurement 432 and measurement 442) does not provide additional information as illustrated in FIG. 4.

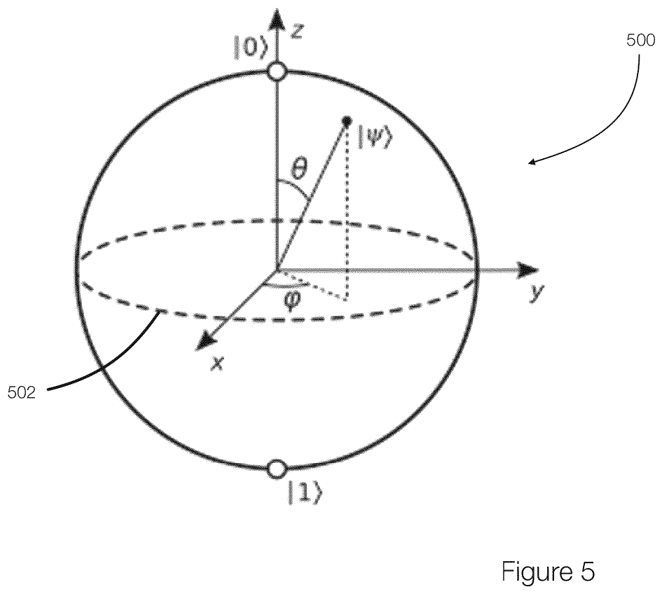

More specifically, without additional gates, the measurement 442 occurs along the same axis as the measurement 432, thus no additional information is obtained from the measurement 442. For example, FIG. 5 illustrates an example of a Bloch sphere. Assuming that measurements in the quantum circuit 400 are performed with respect to the z axis, all states along the dotted line 502 look the same. This results in 50/50 1s and 0s during measurement.

Embodiments of the invention distinguish measurements of the qubits 302 and 402 by introducing a second axis of measurement. Measuring against the x or y axis enough times would reduce the output to 2 possible points. Measuring against both of the x or y axes would correctly identify a single point. This may be impacted by the precision of the measurement and the number of shots (e.g., modulo the precision of the measurement and the number of shots).

In the auxiliary qubit 402, the axis of measurement is changed in some examples. Changing the axis of measurement may include adding at least one gate to the qubit 402 to, in effect, rotate the qubit (e.g., rotating the Bloch sphere) so that measurement along the z axis in the qubit 402 is equivalent to measuring along either the x or y axis of the original qubit 302.

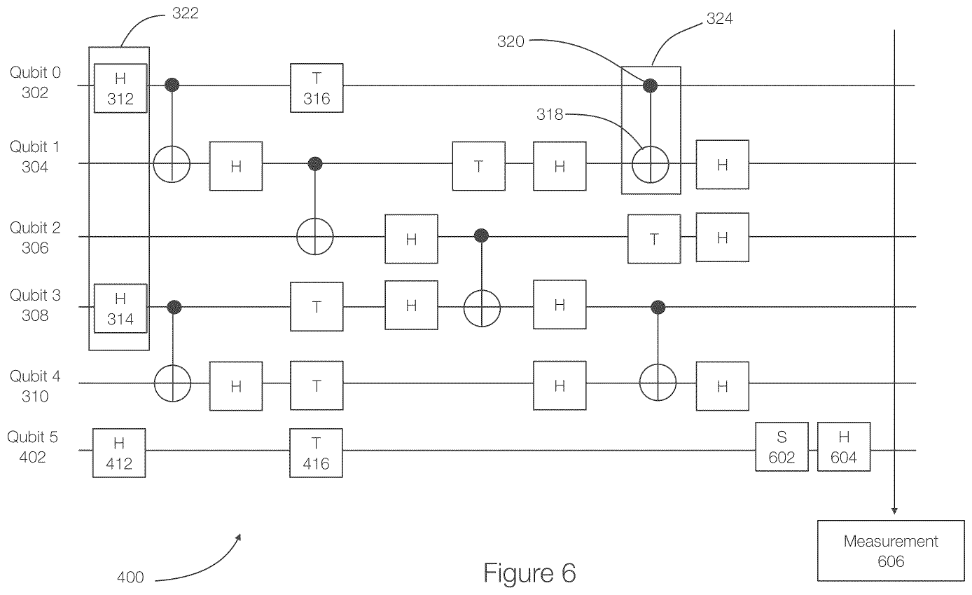

FIG. 6 discloses aspects of measuring replicated qubits along a different axis than the corresponding original qubits. In the quantum circuit 402, for the replicated qubit 402, an S^{†} gate (or S gate) 602 and an H gate 604 in this example are added to the qubit 402. The S^{†} gate (or S gate) 602 applies a phase shift such that the measurement 606 of the qubit 402 occurs with respect to a different axis compared to the original qubit 302. The measurement 606 of the qubit 402 is the same as measuring the qubit 302 along the x or y axis.

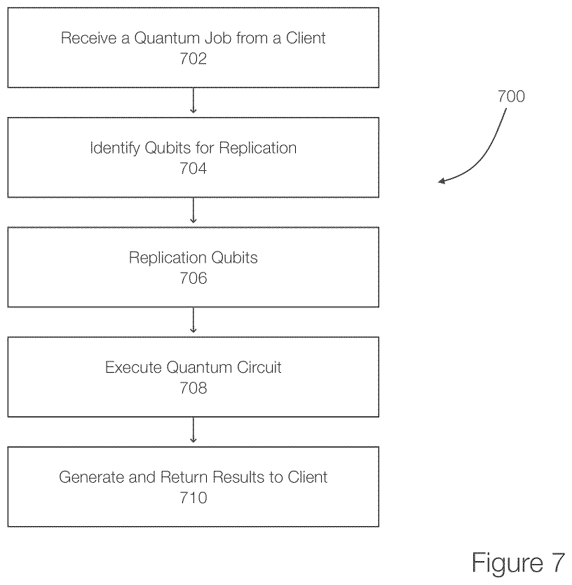

FIG. 7 discloses aspects of executing a quantum circuit in a quantum computing system, which may include an orchestrator. The method 700 includes receiving 702 a quantum job from a client at an orchestrator. The quantum job may include a quantum circuit or the quantum circuit may be generated by the orchestrator.

The orchestrator may identify 704 qubits (one or more) in the quantum circuit for replication. This may depend on the number spare or auxiliary qubits available on the target quantum computing system. Identifying qubits for replication also includes identifying qubits that are separable. Replicating an original qubit may require the quantum circuit to be regenerated (e.g., an original quantum circuit with n qubits is re-created or regenerated as a new quantum circuit with at least n+1 qubits). For example, the original quantum circuit may have 5 qubits. The regenerated quantum circuit may have 6 or more qubits, where the extra qubits are auxiliary qubits that correspond to replicated original qubits.

Once qubits that have separable states are identified and/or the number of qubits to replicate are identified, the identified or selected qubits are replicated 706. Replicating the qubits may include replicating single qubit gates on the original qubits to the same layers in the auxiliary qubits. Two-qubit gates where the original qubit is the control qubit are ignored and not replicated to the auxiliary qubit. In one example, if a 2 qubit gate where the original qubit is the target qubit, a layer may be added to the quantum circuit such that the operation can be performed. Finally, replicating the original qubit includes adding a phase change gate at the end. The phase gate (e.g., an S^{†} gate or S gate) allows the measurement to be performed along a different axis such that additional information is acquired during a single shot or execution of the quantum circuit.

Once the quantum circuit is re-created with auxiliary qubits, the re-created or reconfigured quantum circuit is executed 708 in a quantum computing system. The output of the quantum computing system may be separated into one or more sets as previously described. For example, if a quantum circuit has original qubits 0-4 and qubit 0 is replicated as an auxiliary qubit 5, the output may represent a distribution for 6 qubits. However, this output can be separated into an output for qubits 0-4 and an output for qubits 1-5. The auxiliary qubit, which is measured along a different axis, provides additional information. The information from these two sets may also be recombined when appropriate. In effect, two shots of the quantum circuit are performed in a single shot. As a result, performance is improved as the number of shots may be reduced by a factor of 2 in one example. The overall performance gain may depend on noise and/or other factors.

It is noted that embodiments disclosed herein, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, quantum circuit execution operations, qubit replication operations, quantum circuit re-creation or regeneration operations, or the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide data protection functionality for one or more clients. Another example of a cloud computing environment is one in which processing, data storage, data protection, and other services may be performed on behalf of one or more clients. Some example cloud computing environments in which embodiments may be employed include Microsoft Azure, Amazon AWS, Dell EMC Cloud Storage Services, and Google Cloud. More generally however, the scope of this disclosure is not limited to employment of any particular type or implementation of cloud computing environment.

In addition to the cloud environment, the operating environment may also include one or more clients capable of collecting, modifying, and creating, data. As such, a particular client or server or other computing system may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment.

As used herein, the term ‘data’ or ‘object’ is intended to be broad in scope. Example embodiments are applicable to any system capable of storing and handling various types of objects, in analog, digital, or other form. Synthetic documents and/or corresponding labels are examples of data or objects.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.

Embodiment 1. A method comprising: identifying a quantum circuit having k qubits to be executed in a quantum computing system that includes n qubits (k<n), wherein l of the n qubits are auxiliary qubits, replicating a first qubit of k qubits of the quantum circuit to a first auxiliary qubit, generating a new quantum circuit from that quantum circuit, wherein the new quantum circuit includes the k qubits and the first auxiliary qubit, executing the new quantum circuit in the quantum computing system, and performing a measurement operation to generate an output, where a measured state of the first auxiliary qubit provides different information that a measured state of the first qubit.

Embodiment 2. The method of embodiment 1, further comprising replicating single qubit gates in the first qubit to the first auxiliary qubit.

Embodiment 3. The method of embodiment 1 and/or 2, wherein the single qubit gates are replicated to a same layer in the new quantum circuit.

Embodiment 4. The method of embodiment 1, 2, and/or 3, wherein 2 qubit gates where the first qubit is a control qubit for the 2 qubit gates are not replicated from the first qubit to the first auxiliary qubit.

Embodiment 5. The method of embodiment 1, 2, 3, and/or 4, further comprising adding a phase change gate to the first auxiliary qubit.

Embodiment 6. The method of embodiment 1, 2, 3, 4, and/or 5, further comprising adding a Hadamard gate after the phase change gate to the first auxiliary qubit.

Embodiment 7. The method of embodiment 1, 2, 3, 4, 5, and/or 6, wherein the phase change gate is an S gate or an S dagger gate.

Embodiment 8. The method of embodiment 1, 2, 3, 4, 5, 6, and/or 7, further comprising separating the output into two sets, wherein a first set includes the first qubit and not the first auxiliary qubit and wherein the second set includes the first auxiliary qubit and not the first qubit.

Embodiment 9. The method of embodiment 1, 2, 3, 4, 5, 6, 7, and/or 8, wherein the measurement operation measures the first qubit along a first axis and the first auxiliary qubit from a first axis, wherein the first axis of the first auxiliary qubit corresponds to a second axis of the first qubit.

Embodiment 10. The method of embodiment 1, 2, 3, 4, 5, 6, 7, 8, and/or 9, further comprising automatically identifying qubits in the quantum circuit eligible for replication.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

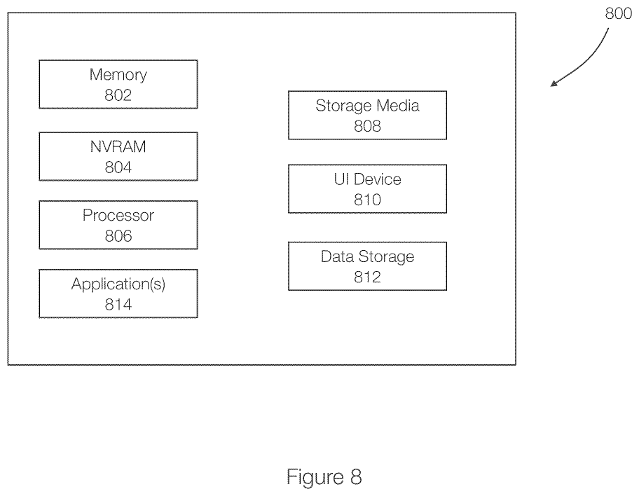

With reference briefly now to FIG. 8, any one or more of the entities disclosed, or implied, by the Figures and/or elsewhere herein, may take the form of, or include, or be implemented on, or hosted by, a physical computing device, one example of which is denoted at 800. As well, where any of the aforementioned elements comprise or consist of a virtual machine (VM), that VM may constitute a virtualization of any combination of the physical components disclosed in FIG. 8.

In the example of FIG. 8, the physical computing device 800 includes a memory 802 which may include one, some, or all, of random access memory (RAM), non-volatile memory (NVM) 804 such as NVRAM for example, read-only memory (ROM), and persistent memory, one or more hardware processors 806, non-transitory storage media 808, UI device 810, and data storage 812. One or more of the memory components 802 of the physical computing device 800 may take the form of solid state device (SSD) storage. As well, one or more applications 814 may be provided that comprise instructions executable by one or more hardware processors 806 to perform any of the operations, or portions thereof, disclosed herein.

The device 800 may also represent a computing system such as a server or set of servers, an edge based computing system, a cloud-based computing system, or the like. The computing system may be localized or distributed in nature.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The device 800 may also represent a physical or virtual machine or server, an edge-based computing system, a cloud-based computing system, server clusters or other computing systems or environments. The device 800 may also represent multiple machines or devices, whether virtual, containerized, or physical. The device 800 may perform or execute steps or acts of the methods illustrated in the Figures.

The device 800 may represent a cloud-based system, an edge-based, system, an on-premise system, or combinations thereof. Document understanding and related operations may be performed using these types of computing environments/systems.

The described embodiments are to be considered in all respects only as illustrative and not restrictive. All changes which come within the meaning and range of equivalency of the claims are to be embraced within their scope.

What is claimed is:

1. A method comprising:
identifying a quantum circuit having k qubits to be executed in a quantum computing system that includes n qubits (k<n), wherein l of the n qubits are auxiliary qubits;
replicating a first qubit of k qubits of the quantum circuit to a first auxiliary qubit;
generating a new quantum circuit from that quantum circuit, wherein the new quantum circuit includes the k qubits and the first auxiliary qubit;
executing the new quantum circuit in the quantum computing system;
performing a measurement operation to generate an output, where a measured state of the first auxiliary qubit provides different information than a measured state of the first qubit.

2. The method of claim 1, further comprising replicating single qubit gates in the first qubit to the first auxiliary qubit.

3. The method of claim 2, wherein the single qubit gates are replicated to a same layer in the new quantum circuit.

4. The method of claim 1, wherein 2 qubit gates where the first qubit is a control qubit for the 2 qubit gates are not replicated from the first qubit to the first auxiliary qubit.

5. The method of claim 1, further comprising adding a phase change gate to the first auxiliary qubit.

6. The method of claim 5, further comprising adding a Hadamard gate after the phase change gate to the first auxiliary qubit.

7. The method of claim 5, wherein the phase change gate is an S gate or an S dagger gate.

8. The method of claim 1, further comprising separating the output into two sets, wherein a first set includes the first qubit and not the first auxiliary qubit and wherein the second set includes the first auxiliary qubit and not the first qubit.

9. The method of claim 8, wherein the measurement operation measures the first qubit along a first axis and the first auxiliary qubit from a first axis, wherein the first axis of the first auxiliary qubit corresponds to a second axis of the first qubit.

10. The method of claim 1, further comprising automatically identifying qubits in the quantum circuit eligible for replication.

11. A non-transitory storage medium having stored therein instructions that are executable by one or more hardware processors to perform operations comprising:
identifying a quantum circuit having k qubits to be executed in a quantum computing system that includes n qubits (k<n), wherein l of the n qubits are auxiliary qubits;
replicating a first qubit of k qubits of the quantum circuit to a first auxiliary qubit;
generating a new quantum circuit from that quantum circuit, wherein the new quantum circuit includes the k qubits and the first auxiliary qubit;
executing the new quantum circuit in the quantum computing system;
performing a measurement operation to generate an output, where a measured state of the first auxiliary qubit provides different information that a measured state of the first qubit.

12. The non-transitory storage medium of claim 11, further comprising replicating single qubit gates in the first qubit to the first auxiliary qubit.

13. The non-transitory storage medium of claim 12, wherein the single qubit gates are replicated to a same layer in the new quantum circuit.

14. The non-transitory storage medium of claim 11, wherein 2 qubit gates where the first qubit is a control qubit for the 2 qubit gates are not replicated from the first qubit to the first auxiliary qubit.

15. The non-transitory storage medium of claim 11, further comprising adding a phase change gate to the first auxiliary qubit.

16. The non-transitory storage medium of claim 15, further comprising adding a Hadamard gate after the phase change gate to the first auxiliary qubit.

17. The non-transitory storage medium of claim 15, wherein the phase change gate is an S gate or an S dagger gate.

18. The non-transitory storage medium of claim 11, further comprising separating the output into two sets, wherein a first set includes the first qubit and not the first auxiliary qubit and wherein the second set includes the first auxiliary qubit and not the first qubit.

19. The non-transitory storage medium of claim 18, wherein the measurement operation measures the first qubit along a first axis and the first auxiliary qubit from a first axis, wherein the first axis of the first auxiliary qubit corresponds to a second axis of the first qubit.

20. The non-transitory storage medium of claim 11, further comprising automatically identifying qubits in the quantum circuit eligible for replication.
